(19) United States
(12) Patent Application Publication
(10) Pub. No.: US 2024/0188503 A1
(43) Pub. Date: Jun. 13, 2024

(54) CUTTER MACHINE

(71) Applicant: MAKITA CORPORATION, Anjo-shi (JP)

(72) Inventor: Kazuya KATO, Anjo-shi (JP)

(73) Assignee: MAKITA CORPORATION, Anjo-shi (JP)

(21) Appl. No.: 18/526,840

(22) Filed: Dec. 1, 2023

(30) Foreign Application Priority Data
Dec. 8, 2022 (JP) 2022-196502

(51) Int. Cl. A01G 3/037

(52) U.S. Cl. CPC A01G 3/037

(57) ABSTRACT

A cutter machine may include a first blade, a second blade configured to rotate relative to the first blade, a base member supporting the first blade and the second blade, a screw member including a head portion and a shaft portion extending from the head portion which is a proximal end of the shaft portion, wherein the screw member fastens the first blade and the base member to each other, a looseness restraint member attached to the shaft portion and configured to be pressed by the head portion to restrain loosening of the screw member, and a fall-off restraint member attached to the shaft portion on a distal side of the shaft portion relative to the looseness restraint member and configured to restrain the looseness restraint member from moving relative to the shaft portion in a direction from a proximal side to the distal side of the shaft portion.

### REFERENCE TO RELATED APPLICATIONS

This application claims priority to Japanese Patent Application No. 2022-196502 filed on Dec. 8, 2022, the contents of which are hereby incorporated by reference into the present application.

### TECHNICAL FIELD

The art disclosed herein relates to a cutter machine.

### BACKGROUND ART

Japanese Patent Application Publication No. 2022-107440 describes a cutter machine including: a first blade; a second blade configured to rotate relative to the first blade; a base member supporting the first blade and the second blade; a screw member including a head portion and a shaft portion extending from the head portion which is a proximal end of the shaft portion and threaded with an outer thread, wherein the screw member fastens the first blade and the base member to each other by having the outer thread screwed with an inner thread; and a looseness restraint member attached to the shaft portion and configured to be pressed by the head portion to restrain loosening of the screw member.

### DESCRIPTION

In such cutter machine as described in Japanese Patent Application Publication No. 2022-107440, the looseness restraint member may fall off the screw member (specifically, from a tip of the shaft portion) when the screw member is being removed from the cutter machine. The present disclosure provides an art configured to suppress a looseness restraint member from falling from a screw member.

A cutter machine disclosed herein may comprise a first blade, a second blade configured to rotate relative to the first blade, a base member supporting the first blade and the second blade, a screw member including a head portion and a shaft portion extending from the head portion which is a proximal end of the shaft portion and threaded with an outer thread, wherein the screw member fastens the first blade and the base member to each other by having the outer thread screwed with an inner thread, a looseness restraint member attached to the shaft portion and configured to be pressed by the head portion to restrain loosening of the screw member, and a fall-off restraint member attached to the shaft portion on a distal side of the shaft portion relative to the looseness restraint member and configured to restrain the looseness restraint member from moving relative to the shaft portion in a direction from a proximal side to the distal side of the shaft portion.

According to the above configuration, the fall-off restraint member configured to restrain the looseness restraint member from moving from the proximal side toward the distal side of the shaft portion is disposed on the screw member. Due to this, the looseness restraint member can be suppressed from falling off the screw member.

The “loosening of the screw member” herein specifically means loosening of the screw member in a state where the screw member is fastened. Also, “the looseness restraint member falling off” herein specifically means the looseness restraint member falling off in a state where the screw member has been removed from the cutter machine.

### BRIEF DESCRIPTION OF DRAWINGS

FIG. 1 illustrates a perspective view of pruning scissors 2 according to an embodiment seen from a front left upper side.

FIG. 2 illustrates an exploded view of components disposed on a front side of the pruning scissors 2 according to the embodiment in which the components are exploded in a left-right direction.

FIG. 3 illustrates an enlarged view of a front part of the pruning scissors 2 according to the embodiment seen from a left side.

FIG. 4 illustrates a cross sectional view of the pruning scissors 2 according to the embodiment in which fastening by a locking screw 44 is complete.

FIG. 5 illustrates an internal structure of the pruning scissors 2 according to the embodiment in which an operation mode of the pruning scissors 2 is a normal mode with a pulling operation not applied on a trigger lever 10, seen from a right side.

FIG. 6 illustrates a perspective view of the pruning scissors 2 according to the embodiment, seeing the trigger lever 10, a gear housing 16, and a sensor substrate 208 seen from a front right upper side.

FIG. 7 illustrates the internal structure of the pruning scissors 2 according to the embodiment in which the operation mode of the pruning scissors 2 is the normal mode with the pulling operation applied on the trigger lever 10, seen from the right side.

FIG. 8 illustrates a perspective view of the pruning scissors 2 according to the embodiment, seeing a movable blade 8 and a blade holder 38 seen from a rear left upper side.

FIG. 9 illustrates a schematic view of the pruning scissors 2 according to the embodiment, indicating how an opening position of the movable blade 8 is switched between a first open position P1 and a second open position P2.

Representative, non-limiting examples of the present disclosure will now be described in further detail with reference to the attached drawings. This detailed description is merely intended to teach a person of skill in the art further details for practicing aspects of the present teachings and is not intended to limit the scope of the present disclosure. Furthermore, each of the additional features and teachings disclosed below may be utilized separately or in conjunction with other features and teachings to provide improved cutter machines as well as methods for using and manufacturing the same.

Moreover, combinations of features and steps disclosed in the following detailed description may not be necessary to practice the present disclosure in the broadest sense, and are instead taught merely to particularly describe representative examples of the present disclosure. Furthermore, various features of the above-described and below-described representative examples, as well as the various independent and dependent claims, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

In one or more embodiments, the looseness restraint member may comprise a first surface facing to the proximal side of the shaft portion and a second surface facing to the distal side of the shaft portion. A shape of the first surface when viewed from the proximal side of the shaft portion and a shape of the second surface when viewed from the distal side of the shaft portion may be different from each other.

If the shape of the first surface when viewed from the proximal side of the shaft portion and the shape of the second surface when viewed from the distal side of the shaft portion are identical, the ability of restraining looseness is not impaired that much even when orientations of the first surface and the second surface are switched. In the above configuration, the shape of the first surface when viewed from the proximal side of the shaft portion and the shape of the second surface when viewed from the distal side of the shaft portion are different from each other. Due to this, if the orientations of the first surface and the second surface are switched, the ability of restraining looseness by the looseness restraint member may be lost. Here, if the looseness restraint member falls from the screw member and the user attaches the looseness restraint member that had fallen back onto the screw member, the orientations of the first surface and the second surface may be switched then. Due to this, the ability of restraining looseness by the looseness restraint member may be lost. Thus, in the above configuration, it is desired in particular that the falling of the looseness restraint member is restrained. According to the above configuration, since the looseness restraint member can be suppressed from falling from the screw member, effect of suppressing the falling of the looseness restraint member is exhibited prominently.

In one or more embodiments, the looseness restraint member may comprise a plate portion extending along a substantial truncated conical shape increasing in diameter in the direction from the proximal side to the distal side of the shaft portion and a plurality of teeth disposed on at least one of an inner circumference of the plate portion and an outer circumference of the plate portion, each of the plurality of teeth protruding in a direction along which the plate portion extends. The fall-off restraint member may be an elastic member having a substantial ring shape.

In the present disclosure, a member configured to compress the looseness restraint member between the head portion and the member will be referred to as “counter member”. In the above configuration, the looseness restraint member has a plurality of teeth biting into at least one of the head portion and the counter portion in order to generate friction torque for restraining the loosening of the screw member. However, if the plate portion is excessively squashed by a force which the head portion and the counter member bring to compress the plate portion (so-called axial force), the plurality of teeth no longer bites into at least one of the head portion and the counter member. As a result of this, the friction torque for restraining the loosening of the screw member is decreased, resulting in less looseness restraining performance by the looseness restraint member. According to the above configuration, the fall-off restraint member attached next to the plate portion enters inside the plate portion (that is, inside the substantially truncated conical shape). The fall-off restraint member having entered inside the plate portion supports the inner side surface of the plate portion in an axial direction. Due to this, since the plate portion can be suppressed from being squashed excessively by the axial force, it can be suppressed that the plurality of teeth no longer bites into at least one of the head portion and the counter member. By virtue of this configuration, friction torque for restraining the loosening of the screw member can be improved, by which the looseness restraining performance by the looseness restraint member can be improved.

In one or more embodiments, the first blade or the base member may comprise a through-hole through which the shaft portion is configured to pass, a contact surface configured to contact the looseness restraint member, and a recess disposed along a periphery of the through-hole and configured to allow at least a part of the fall-off restraint member to retreat to an inner side relative to the contact surface.

The fall-off restraint member is pressed axially by being sandwiched between the looseness restraint member and the counter member and thus deforms. If the fall-off restraint member excessively deforms, the fall-off restraint member may break. According to the above configuration, either of the first blade or the base member corresponding to the counter member comprises the contact surface configured to contact the looseness restraint member and the recess configured to allow at least a part of the fall-off restraint member to retreat to the inner side relative to the contact surface. By virtue of the contact surface and the recess, a space between the looseness restraint member and the counter member is relatively increased. Due to this, deformation amount of the fall-off restraint member when sandwiched between the looseness restraint member and the counter member can be decreased. Accordingly, since excessive deformation of the fall-off restraint member can be suppressed, and also the fall-off restraint member can be suppressed from breaking.

In one or more embodiments, the recess may be smoothly connected to the contact surface.

If a connected part between the recess and the contact surface has an unsmooth shape (e.g., with sharp edges), a load applied on the fall-off restraint member may locally be excessively large when the fall-off restraint member contacts the connected part. Due to this, the fall-off restraint member may break. According to the above configuration, because the connected part between the recess and the contact surface has a smooth shape (e.g., round shape or chamfered shape), the load applied on the fall-off restraint member can be suppressed from becoming excessively large when the fall-off restraint member contacts the connected part. By virtue of this configuration, the fall-off restraint member can be suppressed from breaking.

In one or more embodiments, the cutter machine may further comprise a motor shaft connected to the second blade and an electric motor configured to rotate the motor shaft. By the electric motor being driven, the first blade and the second blade may be rotated relative to each other to perform a cutting operation.

In manually-operated cutter machines where cutting operation (that is, pivoting of a second blade relative to a first blade) is actuated by a force applied by a user, components besides the first and second blades are relatively low-priced. Due to this, it is common to newly replace a cutter machine as a whole when the first and/or second blades have been worn out. Thus, in the manually-operated cutter machines, it is probable that a frequency at which the first blade is removed from the base member (that is, frequency at which the screw member is removed from the cutter machine) is low. Contrary to this, the aforementioned cutter machine is an electric cutter machine in which cutting operation is executed by power from the electric motor. In the electric cutter machines, components besides the first and second blades (such as electric motor) are relatively high-priced. Due to this, when the first blade and/or second blade have worn out, the first blade and/or second blade alone may be newly replaced. That is, the first blade and/or second blade may be replaced. Thus, since in electric cutter machines, the frequency at which the first blade is removed from the base member (that is, frequency at which the screw member is removed from the cutter machine) is presumed to be high, it is especially desired that falling of the looseness restraint member is suppressed. According to the above configuration, the looseness restraint member can be suppressed from falling from the screw member in electric cutter machines. Due to this, effect of suppressing the falling of the looseness restraint member is exhibited prominently.

In one or more embodiments, the fall-off restraint member may be attached to the shaft portion with the fall-off restraint member compressed outward in a radial direction of the shaft portion.

If there is a play between the looseness restraint member and the shaft portion, the fall-off restraint member may not stay stable relative to the shaft portion. If the fall-off restraint member staggers relative to the shaft portion, the fall-off restraint member (or shaft portion) may be worn by the fall-off restraint member and the shaft portion bumping each other. According to the above configuration, since there is no play between the fall-off restraint member and the shaft portion, the fall-off restraint member can be suppressed from staggering relative to the shaft portion. Due to this, the fall-off restraint member (or shaft portion) can be suppressed from being worn.

In one or more embodiments, the fall-off restraint member may be hidden by the looseness restraint member when viewed from the proximal side of the shaft portion.

If the fall-off restraint member is not hidden by the looseness restraint member when the fall-off restraint member is viewed from the proximal side of the shaft portion, design of appearance may be impaired. According to the above configuration, design of a cutter machine can be improved because the fall-off restraint member is hidden by the looseness restraint member when viewed from the proximal side of the shaft portion.

### EMBODIMENT

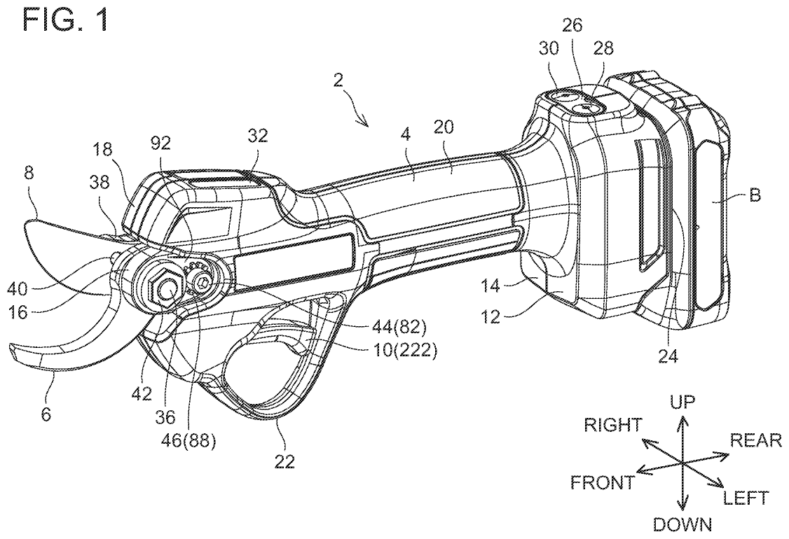

As shown in FIG. 1, a cutter machine according to the present embodiment is pruning scissors 2. The pruning scissors 2 are mainly used for pruning branches of trees. The pruning scissors 2 are portable, and are configured to be gripped with one hand by a user.

The pruning scissors 2 comprise a housing 4, a stationary blade 6, a movable blade 8, a trigger lever 10, and a battery pack B. Although details will be described later, the pruning scissors 2 perform a cutting operation by causing the movable blade 8 to pivot relative to the stationary blade 6 by using power supplied from the battery pack B upon a pulling operation on the trigger lever 10. The stationary blade 6 and the movable blade 8 are constituted of metal (e.g., iron alloy). The battery pack B houses a rechargeable secondary battery therein.

The housing 4 comprises a left housing 12, a right housing 14, a gear housing 16, and a cover housing 18. The left housing 12, the right housing 14, the gear housing 16, and the cover housing 18 are all constituted of a plastic. The left housing 12 and the right housing 14 are fixed to each other by screws (not shown). The gear housing 16 is supported by the left housing 12 and the right housing 14. The cover housing 18 is fixed to the left housing 12 and the right housing 14 by screws (not shown). The housing 4 comprises a grip portion 20 for the user to grip, a protector portion 22 for protecting the trigger lever 10, and a battery receptacle 24 for removably attaching the battery pack B.

In FIGS. 1 to 9, in a longitudinal direction of the grip portion 20, a direction from the battery receptacle 24 to the stationary blade 6 and the movable blade 8 will be designated as a front direction/frontward, and a direction from the stationary blade 6 and the movable blade 8 to the battery receptacle 24 will be designated as a rear direction/rearward. Then, a direction which is perpendicular to the front and rear directions and also extends along a pivot axis of the movable blade 8 will be designated as a left-right direction. In the left-right direction, a direction from the movable blade 8 to the stationary blade 6 will be designated as a left direction/leftward and a direction from the stationary blade 6 to the movable blade 8 will be designated as a right direction/rightward. A direction which is perpendicular to the front and rear directions and the left-right direction will be designated as an up-down direction.

An operation unit 26 is disposed on a rear upper part of the housing 4. The operation unit 26 comprises a power switch 28 for switching on/off of a main power and an adjusting switch 30 (details thereof will be described later), for example. An indicator unit 32 is disposed on a front upper part of the housing 4. The indicator unit 32 comprises LED(s) (not shown) for indicating a status of on/off of the main power and/or a status of a remaining charge level in the battery pack B.

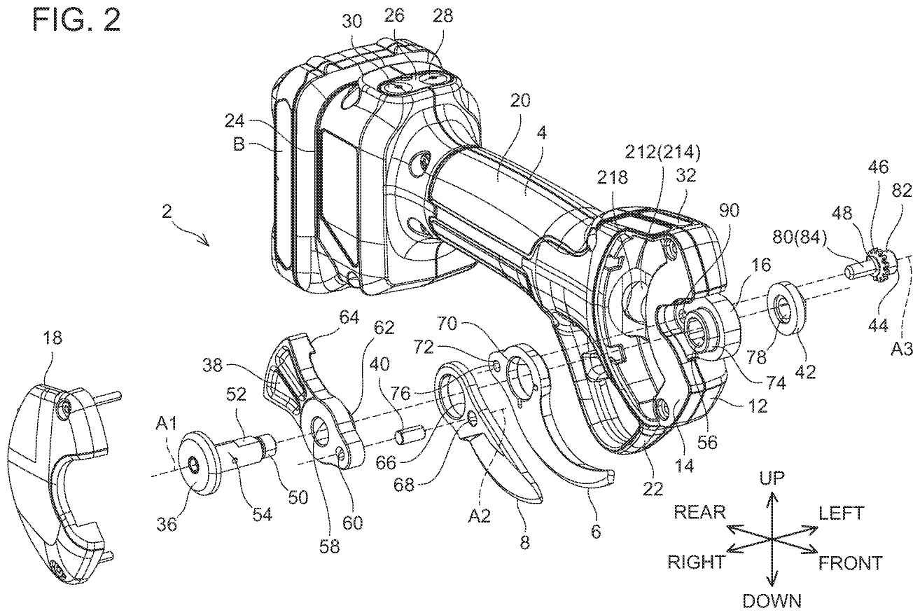

As shown in FIG. 2, the pruning scissors 2 comprises a joint fastening bolt 36 for fastening multiple components together, a blade holder 38, a coupling pin 40, a joint fastening nut 42 for fastening multiple components together, a locking screw 44, a locking plate 46, and an O ring 48. In the present embodiment, a center axis of the joint fastening bolt 36 (specifically, columnar portion 54) is depicted as “axis A1”. A center axis of the coupling pin 40 is depicted as “axis A2”. A center axis of the locking screw 44 (specifically, shaft portion 80) is depicted as “axis A3”. Each of the axes A1, A2, A3 extends along the left-right direction.

The joint fastening bolt 36 has an outer thread portion 50, a fitting portion 52, and the columnar portion 54 formed thereon sequentially from the left. The joint fastening bolt 36 is a so-called shoulder bolt. The fitting portion 52 has a shape corresponding to a fitting hole 56 defined in the gear housing 16.

The blade holder 38 comprises a first through-hole 58 and a second through-hole 60 disposed on a front side of the first through-hole 58. The first through-hole 58 is configured to receive rotatably the columnar portion 54 of the joint fastening bolt 36. Due to this, the blade holder 38 can rotate about the axis A1. A right part of the coupling pin 40 is inserted into the second through-hole 60. The coupling pin 40 is fixed to the blade holder 38 in a state being inserted through the second through-hole 60. A left surface of the blade holder 38 has a first cylindrical portion 62 protruding leftward from a periphery of the first through-hole 58 and a bevel gear 64 defined thereon.

The movable blade 8 comprises a third through-hole 66 into which the first cylindrical portion 62 of the blade holder 38 is inserted and a fourth through-hole 68 into which a left part of the coupling pin 40 is inserted. The movable blade 8 is constrained by the blade holder 38 with respect to the axis A1 and the axis A2. That is, the movable blade 8 is fixed to the blade holder 38 in the front-rear and up-down directions. Due to this, the movable blade 8 is configured to rotate about the axis A1 unitedly with the blade holder 38.

The stationary blade 6 comprises a fifth through-hole 70 and a sixth through-hole 72 disposed on a rear side of the fifth through-hole 70. A second cylindrical portion 74 protruding rightward from a right surface of the gear housing 16 is inserted into the fifth through-hole 70. An inner side surface of the sixth through-hole 72 is threaded with an inner thread 76.

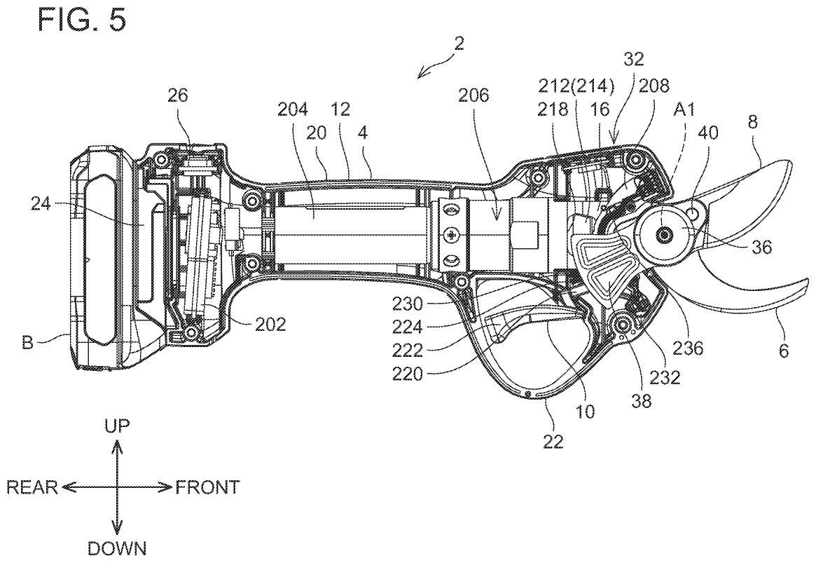

The joint fastening nut 42 comprises an inner thread portion 78 corresponding to the outer thread portion 50 of the joint fastening bolt 36. The joint fastening bolt 36 and the joint fastening nut 42 fasten the blade holder 38, the movable blade 8, and the stationary blade 6 to the gear housing 16, by having the outer thread portion 50 screwed with the inner thread portion 78. Specifically, the joint fastening bolt 36 and the joint fastening nut 42 constrain the blade holder 38, the movable blade 8, and the stationary blade 6 with respect to the left-right direction. A user can adjust a force (hereafter, fastening force) of fastening the gear housing 16, the stationary blade 6, the movable blade 8, and the blade holder 38 in the left-right direction by tightening (or loosening) the joint fastening nut 42 relative to the joint fastening bolt 36. Here, if the fastening force is too weak, a gap between the stationary blade 6 and the movable blade 8 widens, by which cutting performance by the pruning scissors 2 may deteriorate. Contrary to this, if the fastening force is too strong, resistance applied on the movable blade 8 increases when the movable blade 8 is made to pivot relative to the stationary blade 6. This may cause the load applied on an electric motor 204 (see FIG. 5) which rotates the movable blade 8 to be increased, and/or may cause charge of the battery pack B to be consumed at a quicker pace. Thus, there is a suitable numerical range for fastening torque of the joint fastening nut 42 relative to the joint fastening bolt 36.

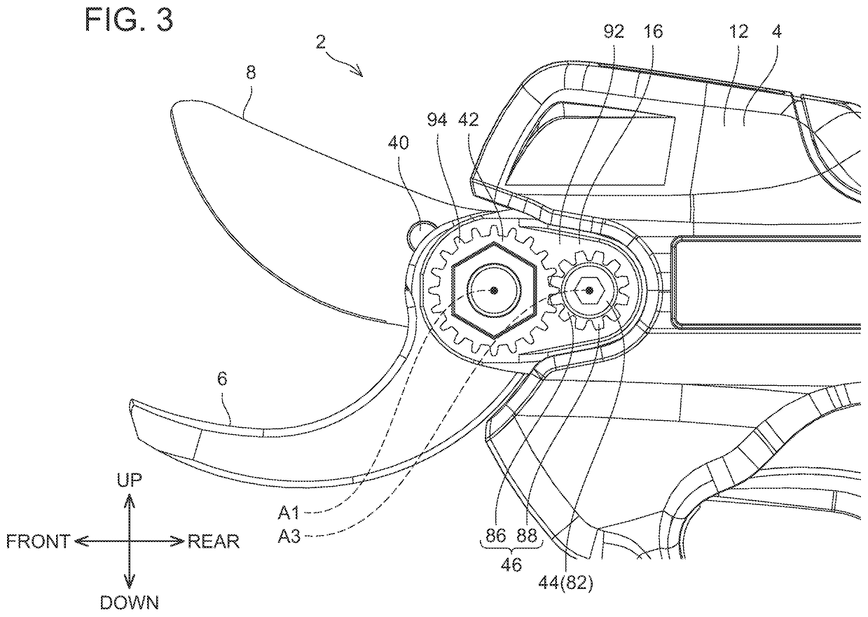

The locking screw 44 comprises the shaft portion 80 and a head portion 82. The shaft portion 80 is threaded with an outer thread 84 corresponding to the inner thread 76 of the stationary blade 6. The locking screw 44 is constituted of metal (e.g., iron alloy). The locking plate 46 and the O ring 48 are attached about the shaft portion 80 of the locking screw 44. The locking plate 46 can be regarded as a so-called washer. The locking plate 46 is constituted of metal (e.g., iron alloy). The O ring 48 is constituted of rubber (e.g., NBR). The O ring 48 is disposed on a distal side of the shaft portion 80 relative to the locking plate 46. An inner diameter of the O ring 48 in a state where the O ring 48 is unloaded is smaller than an outer diameter of the shaft portion 80. Due to this, the O ring 48 is attached to the shaft portion 80 in a state being spread outward in a radial direction of the axis A3 by the shaft portion 80. An outer diameter of the O ring 48 in this state is greater than an inner diameter of the locking plate 46. Due to this, as the locking plate 46 is moving toward the distal side of the shaft portion 80, the locking plate 46 contacts the O ring 48 and it is stopped from going toward the distal side of the shaft portion 80 any farther. Due to this, the locking plate 46 is suppressed from falling off the shaft portion 80 when the distal end of the shaft portion 80 is directed downward. Further, as shown in FIG. 3, the locking plate 46 comprises a plate body 86 and a plurality of teeth 88 arranged along an outer circumference of the plate body 86. The O ring 48 (see FIG. 2) is hidden by the locking plate 46 when the O ring 48 is viewed from the left side.

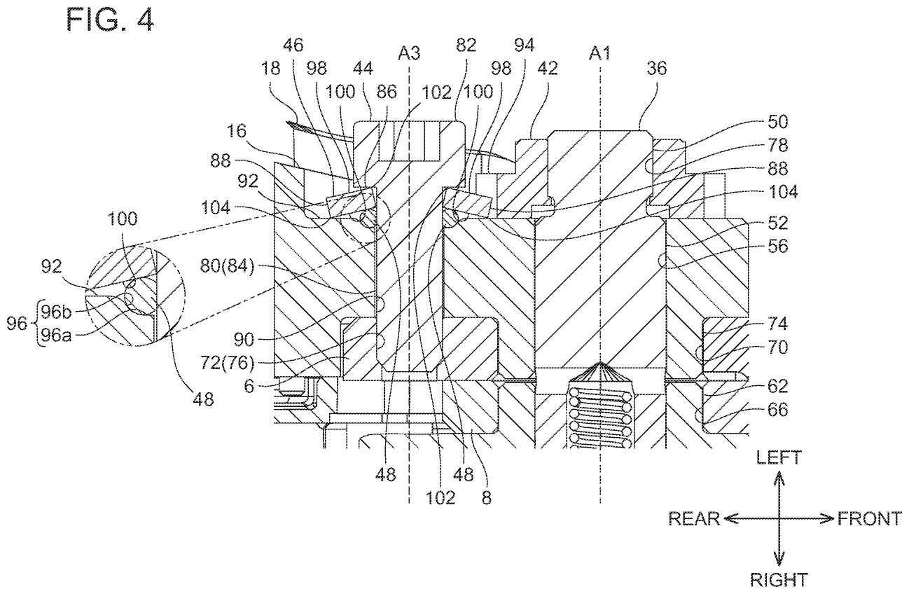

As shown in FIG. 2, the gear housing 16 has a seventh through-hole 90 through which the shaft portion 80 of the locking screw 44 is configured to pass defined therein on the rear side of the fitting hole 56. The outer thread 84 is screwed with the inner thread 76 of the stationary blade 6 with the shaft portion 80 of the locking screw 44 inserted through the seventh through-hole 90, by which the stationary blade 6 is fastened to the gear housing 16 as shown in FIG. 4. Due to this, the stationary blade 6 is fixed to the gear housing 16.

As shown in FIG. 3, a contact surface 92 for receiving the joint fastening nut 42 and the locking plate 46 is arranged on a left surface of the gear housing 16. The contact surface 92 is a plane substantially perpendicular to the left-right direction. Further, a plurality of teeth 94 corresponding to the plurality of teeth 88 of the locking plate 46 is defined on an outer circumference of the joint fastening nut 42. Illustration of the plurality of teeth 94 of the joint fastening nut 42 is omitted for simplicity in the other drawings besides FIGS. 3 and 4. When the stationary blade 6 is to be fixed to the gear housing 16, fastening of those components is carried out by using the locking screw 44, with the plurality of teeth 88 of the locking plate 46 meshed with the plurality of teeth 94 of the joint fastening nut 42. Since rotation of the locking plate 46 relative to the gear housing 16 is prohibited in a state where the fastening by using the locking screw 44 is completed, rotation of the joint fastening nut 42 meshed with the locking plate 46 is also prohibited. Due to this, inadvertent change in the fastening force, such as by loosening of the joint fastening nut 42 can be suppressed.

Further, when the fastening force should be adjusted by tightening (or loosening) the joint fastening nut 42, the locking screw 44 needs to be firstly loosened and then the locking screw 44 needs to be removed. When the locking plate 46 is shifted leftward along the axis A3 upon removing the locking screw 44, the meshing between the joint fastening nut 42 and the locking plate 46 is released. Due to this, the rotation of the joint fastening nut 42 is allowed, enabling the adjustment of the fastening force.

As shown in FIG. 4, the gear housing 16 comprises a recess 96 recessed rightward from the contact surface 92 and disposed along a periphery of the seventh through-hole 90. The recess 96 comprises a bottom surface 96a and an angled surface 96b. The bottom surface 96a is connected with the periphery of the seventh through-hole 90 and extends substantially parallel to the contact surface 92. The angled surface 96b smoothly connects the bottom surface 96a and the contact surface 92. The angled surface 96b gradually approaches the bottom surface 96a as it is closer to the axis A3. The angled surface 96b gradually approaches the contact surface 92 as it separates away from the axis A3. A depth of the recess 96 (specifically, the bottom surface 96a) from the contact surface 92 is a substantially half of a width of the unloaded O ring 48 in the left-right direction.

A left surface 98 of the locking plate 46 (the plate body 86 and the plurality of teeth 88) and a right surface 100 of the locking plate 46 (the plate body 86 and the plurality of teeth 88) are both a substantially truncated conical surface which increases in diameter toward the distal side of the shaft portion 80. That is, the locking plate 46 (the plate body 86 and the plurality of teeth 88) has a shape extending along a substantially truncated cone increasing in diameter toward the distal side of the shaft portion 80.

In the state where the fastening by using the locking screw 44 is completed, a left corner portion 102 of the plate body 86 contacts the head portion 82 of the locking screw 44. A right corner portion 104 (this may also be regarded as respective corners of the plurality of teeth 88) of the plate body 86 contacts the contact surface 92. Under this state, the left corner portion 102 bites into the head portion 82 while on the other hand the right corner portion 104 bites into the contact surface 92. Due to these, since friction torque which suppresses rotation of the head portion 82 relative to the contact surface 92 is generated, loosening of the locking screw 44 is suppressed.

Further, in the state where the fastening by using the locking screw 44 is completed, the O ring 48 is pressed between the bottom surface 96a of the recess 96 and the right surface 100 of the plate body 86. Under this state, the O ring 48 biases the right surface 100 of the plate body 86 leftward against the bottom surface 96a (i.e., the gear housing 16). Due to this, the locking plate 46 can be suppressed from being squashed by the head portion 82 of the locking screw 44. That is, the locking plate 46 can be suppressed from being deformed in an axial direction of the axis A3.

Elastic restoring force by the locking plate 46 and elastic restoring force by the O ring 48 are applied on the locking screw 44 as axial force. That is, both of the locking plate 46 and the O ring 48 are members which apply the axial force to the locking screw 44. Here, in an aspect of applying the axial force onto the locking screw 44, the O ring 48 preferably squashes at an appropriate degree so that a contact area with other members (the gear housing 16 and the locking plate 46) can be secured. On the other hand, in an aspect of durability, the O ring 48 preferably has a certain degree of firmness. Given these aspects, a tensile strength of the O ring 48 is preferably within a range of 10 MPa to 30 MPa, for example. The tensile strength herein mentioned is used as one of indexes indicative of the firmness of the O ring 48. The tensile strength of the O ring 48 according to the present embodiment is approximately 20 MPa.

As shown in FIG. 5, the pruning scissors 2 further comprise a control device 202, the electric motor 204, a power transmission mechanism 206, and a sensor substrate 208. The control device 202, the electric motor 204, the power transmission mechanism 206, and the sensor substrate 208 are housed inside the housing 4. The control device 202 is disposed in a rear part of the housing 4. The electric motor 204 is disposed in front of the control device 202. A longitudinal direction of the electric motor 204 extends along the front-rear direction. The power transmission mechanism 206 is disposed in front of the electric motor 204. The sensor substrate 208 is disposed in a front part of the housing 4.

The control device 202 comprises a memory, a CPU, and the like. The control device 202 is electrically connected with each of the operation unit 26, the indicator unit 32, the electric motor 204, and the sensor substrate 208. With the battery pack B attached to the battery receptacle 24, the control device 202 and the battery pack B are electrically connected. The control device 202 is configured to control operation of the pruning scissors 2 in accordance with a certain program stored in the memory. For example, the control device 202 switches between a state allowing power supply from the battery pack B to the electric motor 204 and a state shutting off the power supply from the battery pack B to the electric motor 204 depending on the on/off state of the main power. The control device 202 also controls the indicator unit 32 so that it displays the on/off state of the main power and/or remaining charge level of the battery pack B.

The electric motor 204 is a brushless motor, for example. The electric motor 204 rotates a motor shaft (not shown) extending along the front-rear direction by being supplied with power.

The power transmission mechanism 206 comprises a planetary gear mechanism (not shown) coupled to the aforementioned motor shaft (not shown) and a gear shaft 212 coupled to the planetary gear mechanism. The planetary gear mechanism reduces rotation of the motor shaft and transmits the same to the gear shaft 212. That is, the planetary gear mechanism functions as a gear reducer. Also, the gear shaft 212 is supported rotatably about an axis along the front-rear direction by a bearing (not shown) disposed inside the gear housing 16. A bevel gear 214 corresponding to the bevel gear 64 (see FIG. 2) defined on the left surface of the blade holder 38 is defined on a front part of the gear shaft 212. A part of the gear shaft 212 (the bevel gear 214) meshes with the bevel gear 64 of the blade holder 38 through an opening 218 defined in the right surface of the gear housing 16. The bevel gears 64, 214 each converts rotation of the gear shaft 212 into rotation of the blade holder 38 as well as the movable blade 8 about the axis A1. For this reason, when the electric motor 204 is driven, power is transmitted to the movable blade 8 via the motor shaft, the planetary gear mechanism, the gear shaft 212, and the bevel gears 64, 214. Due to this, the movable blade 8 pivots.

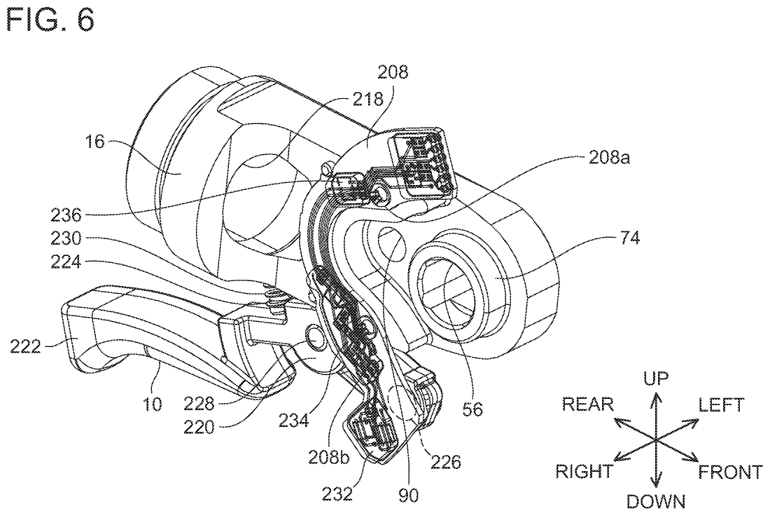

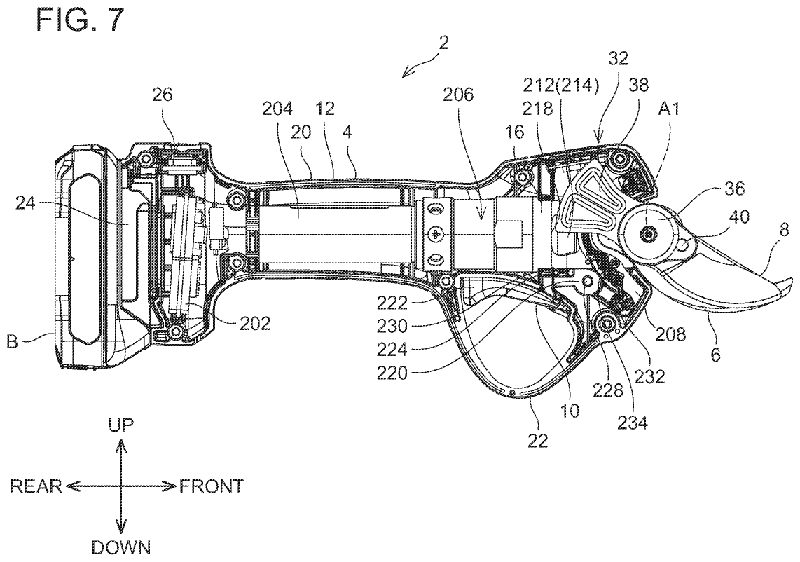

As shown in FIG. 6, the trigger lever 10 comprises a base portion 220, an operation portion 222 extending from a rear end of the base portion 220 and a vicinity thereof in a rear down direction, and a projecting portion 224 projecting upward from an upper surface of the base portion 220. A magnet 226 is fixed to a right surface of the base portion 220. A rotation pin 228 extending in the left-right direction extends through a center of the base portion 220. The rotation pin 228 is rotatably supported by the gear housing 16. Due to this, the trigger lever 10 is configured to rotate about the rotation pin 228. As shown in FIG. 5, the operation portion 222 is a part of the trigger lever 10 that is exposed outside the housing 4 and configured to be operated by the user. A compression spring 230 is attached around the projecting portion 224. The compression spring 230 is inside a recess (not shown) recessed in a lower surface of the gear housing 16. Due to this, the compression spring 230 is held between the gear housing 16 and the trigger lever 10. The compression spring 230 biases the operation portion 222 of the trigger lever 10 downward against the gear housing 16. Due to this, in a state where the operation portion 222 is not being operated by the user, the trigger lever 10 is held in a position shown in FIG. 5. Upon the user performs a pulling operation on the operation portion 222, the trigger lever 10 rotates clockwise as seen from the right side against biasing force of the compression spring 230. If the operation portion 222 is pulled at maximum by the user, the trigger lever 10 is placed in a position shown in FIG. 7.

As shown in FIG. 6, the sensor substrate 208 is fixed to the gear housing 16 by screws 208a, 208b. The sensor substrate 208 extends substantially perpendicular to the left-right direction. A first magnetic sensor 232, a second magnetic sensor 234, and a third magnetic sensor 236 are disposed in the sensor substrate 208. The first magnetic sensor 232 is disposed at a lower end of the sensor substrate 208 and a vicinity thereof. The second magnetic sensor 234 is on a rear upper side of the first magnetic sensor 232. The third magnetic sensor 236 is above the second magnetic sensor 234. The first magnetic sensor 232, the second magnetic sensor 234, and the third magnetic sensor 236 are configured to detect magnetism and output a detection result thereof to the control device 202 (see FIG. 5). The detection result outputted to the control device 202 may indicate a magnetic strength, and/or an orientation of magnetic field, for example.

When the trigger lever 10 is pull-operated, a position of the magnet 226 relative to the sensor substrate 208 changes. For example, when the trigger lever 10 is at the position shown in FIG. 5, the magnet 226 (see FIG. 6) is at a position facing a part of a left surface of the sensor substrate 208 where the first magnetic sensor 232 (see FIG. 6) is disposed. When the trigger lever 10 is at the position shown in FIG. 7, the magnet 226 is at a position facing a part of the left surface of the sensor substrate 208 where the second magnetic sensor 234 (see FIG. 6) is disposed. When the position of the magnet 226 changes, magnetism detected by the first magnetic sensor 232, the second magnetic sensor 234, and the third magnetic sensor 236 changes. Due to this, the control device 202 (see FIG. 5) can determine whether the trigger lever 10 is pull-operated based on output from at least one of the first magnetic sensor 232, the second magnetic sensor 234, and the third magnetic sensor 236 (in the present embodiment, from the first magnetic sensor 232). Further, the control device 202 can specify a pulled amount at which the trigger lever 10 is pulled based on output from at least one of the first magnetic sensor 232, the second magnetic sensor 234, and the third magnetic sensor 236.

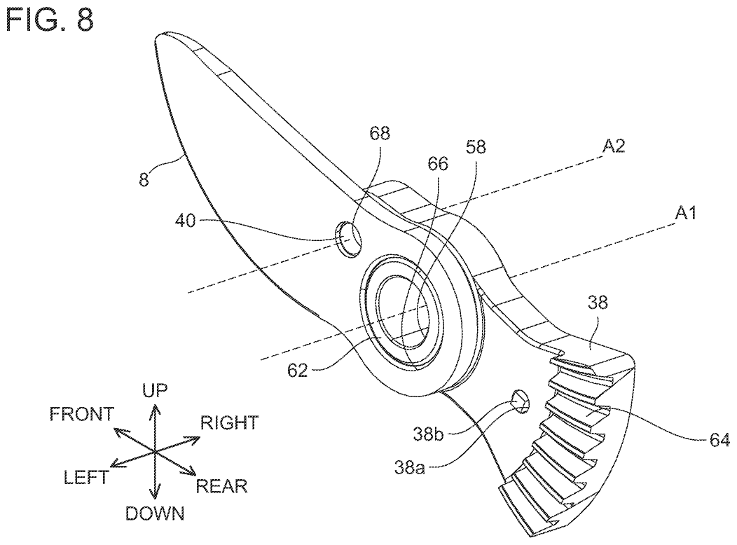

As shown in FIG. 8, the left surface of the blade holder 38 has an attaching hole 38a defined between the first cylindrical portion 62 and the bevel gear 64. A magnet 38b is attached in the attaching hole 38a. When the movable blade 8 and the blade holder 38 pivot about the axis A1, a position of the magnet 38b relative to the sensor substrate 208 changes. For example, when the blade holder 38 is at a position shown in FIG. 5, the magnet 38b (see FIG. 8) is at a position facing the second magnetic sensor 234 (see FIG. 6). When the blade holder 38 is at a position shown in FIG. 7, the magnet 38b is at a position facing the third magnetic sensor 236 (see FIG. 6). When the position of the magnet 38b changes, magnetism detected by the first magnetic sensor 232, the second magnetic sensor 234, and the third magnetic sensor 236 changes. Due to this, the control device 202 (see FIG. 5) can specify a pivoting angle of the movable blade 8 (that is, the position of the movable blade 8 relative to the housing 4) based on output from at least one of the first magnetic sensor 232, the second magnetic sensor 234, and the third magnetic sensor 236 (in the present embodiment, from the second magnetic sensor 234 and the third magnetic sensor 236).

### (Normal Mode of Pruning Scissors 2)

Hereafter, operation of the pruning scissors 2 in a normal time will be described. The normal time herein means a time right after the main power is turned on and when the user is conducting a cutting work. In the present embodiment, an operation mode of the pruning scissors 2 at this time will be referred to as “normal mode”.

In a state where the trigger lever 10 is not pull-operated as shown in FIG. 5, the control device 202 drives the electric motor 204 so that the movable blade 8 is held at a position open relative to the stationary blade 6 (this position being also called “open position”). When the trigger lever 10 is pull-operated from this state, the control device 202 drives the electric motor 204 so that the movable blade 8 is closed relative to the stationary blade 6 according to the pulled degree of the trigger lever 10. Specifically, the control device 202 causes the movable blade 8 to pivot relative to the stationary blade 6 by a pivoting amount corresponding to the pulled amount of the trigger lever 10. When the trigger lever 10 is pull-operated to the maximum as shown in FIG. 7, the movable blade 8 is held at a position closed relative to the stationary blade 6 (this position being also called “closed position”). When the pull-operation onto the trigger lever 10 is released from this state, the control device 202 drives the electric motor 204 so that the movable blade 8 is returned to the open position. As such, the user can cause the pruning scissors 2 to do the cutting work by pull-operating the trigger lever 10.

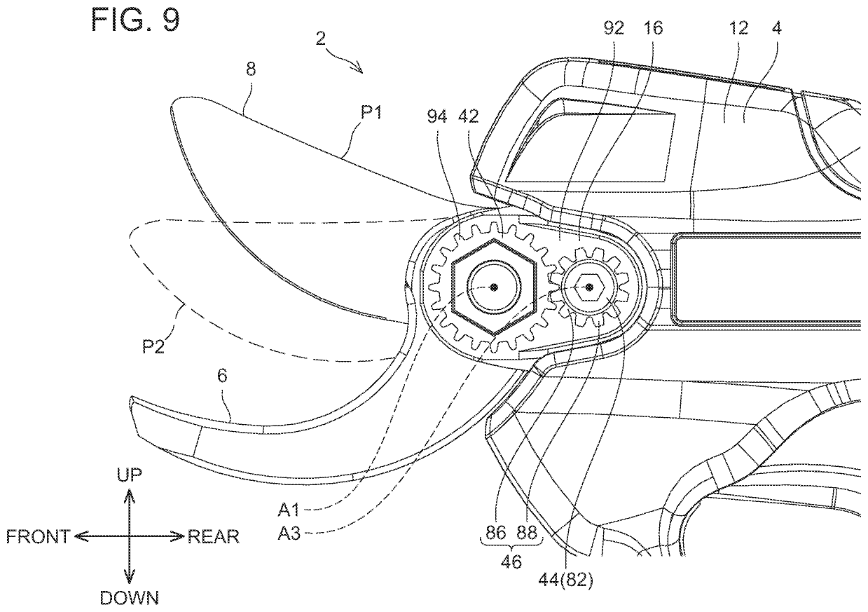

As shown in FIG. 9, the control device 202 (see FIG. 5) switches the open position of the movable blade 8 between a first open position P1 and a second open position P2 which is at a position closed at a greater degree than the first open position P1 according to a first operation (e.g., short press operation) to the adjusting switch 30 (see FIG. 1). Due to this, the user can select an opening position according to a size of an object to be cut. Here, the open position may not be limited to the first open position P1 and the second open position P2, but may be switched to another position.

### (Fine Adjustment Mode for Cutting Depth of Pruning Scissors 2)

When a second operation (long press) is applied onto the adjusting switch 30 (see FIG. 1), the control device 202 switches the operation mode of the pruning scissors 2 to a cutting depth fine adjustment mode for finely adjusting a cutting depth by the stationary blade 6 and the movable blade 8. The cutting depth herein mentioned means a width of a part where the stationary blade 6 and the movable blade 8 overlap in a circumferential direction of the axis A1 when the movable blade 8 is in the closed position. If the cutting depth is shallow, the object to be cut may not be cut completely by the stationary blade 6 and the movable blade 8. Although this is not shown, in the cutting depth fine adjustment mode, the control device 202 gradually increases the cutting depth each time the trigger lever 10 is pull-operated. The control device 202 returns the cutting depth to the original depth once the pulling operation onto the trigger lever 10 is conducted a certain number of times. Due to this, the user can adjust the cutting depth to a suitable depth by conducting the pulling operation onto the trigger lever 10. Here, when a third operation (short press or long press) is applied onto the adjusting switch 30 in the cutting depth fine adjustment mode, the control device 202 switches the operation mode of the pruning scissors 2 to the normal mode.

### (Variants)

The cutting machine may be manually-operated pruning shears. For example, the cutting machine may be a pair of grips pivotable relative to each other to which blades similar to the stationary blade 6 and/or the movable blade 8 are fixed. In this case, the grips and the blades may be fixed to each other by the locking screw 44 fastening the blades to the grips. One of the grips and the blades (i.e., the grips or the blades) may be threaded with the inner thread 76 corresponding to the outer thread 84 of the locking screw 44. The other of the grips and the blades may comprise the contact surface 92 and/or the recess 96.

A shape of the locking plate 46 may be suitably modified. For example, the locking plate 46 may have a substantially disc shape. Further, the locking plate 46 may be symmetrical in the left-right direction.

As a member for restraining looseness of the locking screw 44, another member than the locking plate 46 may be attached to the locking screw 44. For example, a toothed washer, a wave washer, a cup washer may be attached to the locking screw 44 as a member for restraining the looseness of the locking screw 44.

As a member for restraining falling off of the locking plate 46, another member than the O ring 48 may be attached to the locking screw 44. For example, as a member for restraining falling off of the locking plate 46, a ring-shaped member (e.g., rubber band) having a different shape from the O ring 48 may be attached to the locking screw 44.

The recess 96 may not be defined on the gear housing 16.

The angled surface 96b of the recess 96 may not smoothly connect the bottom surface 96a and the contact surface 92. That is, an inclination angle of the angled surface 96b may discretely change between the bottom surface 96a and the contact surface 92.

The inner thread 76 may be defined on the seventh through-hole 90, instead of being on the sixth through-hole 72. In this case, the outer thread 84 of the locking screw 44 may extend through the sixth through-hole 72 to be screwed with the inner thread 76 defined on the seventh through-hole 90. In the state where the fastening by using the locking screw 44 is complete, the stationary blade 6 may be sandwiched between the head portion 82 of the locking screw 44 and the gear housing 16.

Material constituting each component (e.g., the housing 4, the stationary blade 6, the movable blade 8, the locking screw 44, the locking plate 46, and the O ring 48) of the pruning scissors 2 may be suitably changed. For example, the housing 4 may be constituted of metal such as aluminum alloy. For example, each of the stationary blade 6, the movable blade 8, the locking screw 44, and the locking plate 46 may be constituted of metal other than iron alloy. For example, the O ring 48 may be constituted of rubber such as SBR, Si, SR. Also, the O ring 48 may be constituted of elastomer instead of rubber.

The operation mode of the pruning scissors 2 may not be limited to the normal mode and the cutting depth fine adjustment mode, but may be switched to another mode.

The pruning scissors 2 may comprise a power supply cable connectable to an exterior power source, instead of the battery receptacle 24. The exterior power source herein may be a commercial power source, or a mobile power source. The power source may be a device configured to receive a plurality of battery packs B, and thus configured to supply power from the plurality of battery packs B to the pruning scissors 2.

### (Correspondence Relations)

Given the above, in one or more embodiments, the pruning scissors 2 (example of cutter machine) comprises: the stationary blade 6 (example of first blade); the movable blade 8 (example of second blade) configured to rotate relative to the stationary blade 6, the gear housing 16 (example of base member) supporting the stationary blade 6 and the movable blade 8; the locking screw 44 (example of screw member) including the head portion 82 and the shaft portion 80 extending from the head portion 82 which is the proximal end of the shaft portion 80 and threaded with the outer thread 84, wherein the locking screw 44 fastens the stationary blade 6 and the gear housing 16 to each other by having the outer thread 84 screwed with the inner thread 76; the locking plate 46 (example of looseness restraint member) attached to the shaft portion 80 and configured to be pressed by the head portion 82 to restrain loosening of the locking screw 44; and the O ring 48 (example of fall-off restraint member) attached to the shaft portion 80 on the distal side of the shaft portion 80 relative to the locking plate 46 and configured to restrain the locking plate 46 from moving relative to the shaft portion 80 in a direction from the proximal side to the distal side of the shaft portion 80.

According to the above configuration, the O ring 48 configured to restrain the locking plate 46 from moving from the proximal side toward the distal side of the shaft portion 80 is disposed on the locking screw 44. Due to this, the locking plate 46 can be suppressed from falling off the locking screw 44.

In one or more embodiments, the locking plate 46 comprises: the left surface 98 (example of a first surface) facing to the proximal side of the shaft portion 80; and the right surface 100 (example of a second surface) facing to the distal side of the shaft portion 80. The shape of the left surface 98 when viewed from the proximal side of the shaft portion 80 and the shape of the right surface 100 when viewed from the distal side of the shaft portion 80 are different from each other.

If the shape of the left surface 98 when viewed from the proximal side of the shaft portion 80 and the shape of the right surface 100 when viewed from the distal side of the shaft portion 80 are identical, the ability of restraining looseness is not impaired that much even when orientations of the left surface 98 and the right surface 100 are switched. In the above configuration, the shape of the left surface 98 when viewed from the proximal side of the shaft portion 80 and the shape of the right surface 100 when viewed from the distal side of the shaft portion 80 are different from each other. Due to this, if the orientations of the left surface 98 and the right surface 100 are switched, the ability of restraining looseness by the locking plate 46 member may be lost. Here, if the locking plate 46 falls from the locking screw 44 and the user attaches the locking plate 46 that had fallen back onto the locking screw 44, the orientations of the left surface 98 and the right surface 100 may be switched. Due to this, the ability of restraining looseness by the locking plate 46 may be lost. Thus, in the above configuration it is desired in particular that the falling of the locking plate 46 is restrained. According to the above configuration, since the locking plate 46 can be suppressed from falling from the locking screw 44, effect of suppressing the falling of the locking plate 46 is exhibited prominently.

In one or more embodiments, the locking plate 46 comprises: the plate body 86 (example of a plate portion) extending along a substantial truncated conical shape increasing in diameter in the direction from the proximal side to the distal side of the shaft portion 80; and the plurality of teeth 88 disposed on the outer circumference (example of “at least one of an inner circumference of the plate portion and an outer circumference of the plate portion”), each of the plurality of teeth 88 protruding in a direction along which the plate body 86 extends. The O ring 48 is a rubber (example of elastic member) having a substantial ring shape.

In the above configuration, the locking plate 46 has the plurality of teeth 88 biting into the gear housing 16 (example of the counter portion) in order to bring friction torque for restraining the loosening of the locking screw 44. However, if the plate body 86 is excessively squashed by a force which the head portion 82 and the gear housing 16 bring to compress the plate body 86 (so-called axial force), the plurality of teeth 88 no longer bites into the gear housing 16. As a result of this, the friction torque for restraining the loosening of the locking screw 44 is decreased, resulting in less looseness restraining performance by the locking plate 46. According to the above configuration, the O ring 48 attached next to the plate body 86 enters inside the plate body 86 (that is, inside the substantially truncated conical shape). The O ring 48 having entered inside the plate body 86 supports the right surface 100 of the plate body 86 (example of the inner side surface of the plate portion) in an axial direction. Due to this, since the plate body 86 can be suppressed from being squashed excessively by the axial force, it can be suppressed that the plurality of teeth 88 no longer bites into the gear housing 16. By virtue of this configuration, friction torque for restraining the loosening of the locking screw 44 can be improved, by which the looseness restraining function by the locking plate 46 can be improved.

In one or more embodiments, the stationary blade 6 or the gear housing 16 comprises: the seventh through-hole 90 (example of a through-hole) through which the shaft portion 80 is configured to pass; the contact surface 92 configured to contact the locking plate 46; and the recess 96 disposed along the periphery of the seventh through-hole 90 and configured to allow a substantially half of the entire O ring 48 (example of at least a part of the fall-off restraint member) to retreat to an inner side relative to the contact surface 92.

The O ring 48 is pressed axially by being sandwiched between the locking plate 46 and the gear housing 16 and thus deforms. If the O ring 48 excessively deforms, the O ring 48 may break. According to the above configuration, the gear housing 16 comprises the contact surface 92 configured to contact the locking plate 46 and the recess 96 configured to allow the substantially half of the entire O ring 48 to retreat to the inner side relative to the contact surface 92. By virtue of the contact surface 92 and the recess 96, a space between the locking plate 46 and the gear housing 16 is relatively increased. Due to this, deformation amount of the O ring 48 when sandwiched between the locking plate 46 and the gear housing 16 can be decreased. Accordingly, since excessive deformation of the O ring 48 can be suppressed, and also the O ring 48 can be suppressed from breaking.

In one or more embodiments, the recess 96 is smoothly connected to the contact surface 92.

If a connected part between the recess 96 and the contact surface 92 has an unsmooth shape, a load applied on the O ring 48 may locally be excessively large when the O ring 48 contacts the connected part. Due to this, the O ring 48 may break. According to the above configuration, because the connected part between the recess 96 and the contact surface 92 has a smooth shape, the load applied on the O ring 48 can be suppressed from becoming excessively large when the O ring 48 contacts the connected part. By virtue of this configuration, the O ring 48 can be suppressed from breaking.

In one or more embodiments, the pruning scissors 2 comprises the motor shaft connected to the movable blade 8; and the electric motor 204 configured to rotate the motor shaft. By the electric motor 204 being driven, the stationary blade 6 and the movable blade 8 are rotated relative to each other to perform a cutting operation.

In the above mentioned pruning scissors 2, the cutting operation is performed by power from the electric motor 204. In the pruning scissors 2, components besides the stationary blade 6 and movable blade 8 (such as electric motor 204) are relatively high-priced. Due to this, when the stationary blade 6 and/or movable blade 8 have worn out, the stationary blade 6 and/or the movable blade 8 alone may be newly replaced. That is, the stationary blade 6 and/or the movable blade 8 may be replaced. Thus, since in the pruning scissors 2 the frequency at which the stationary blade 6 is removed from the gear housing 16 (that is, frequency at which the locking screw 44 is removed from the pruning scissors 2) is presumed to be high, it is especially desired that falling of the locking plate 46 is suppressed. According to the above configuration, the locking plate 46 can be suppressed from falling from the locking screw 44 in the pruning scissors 2. Due to this, effect of suppressing the falling of the locking plate 46 is exhibited prominently.

In one or more embodiments, the O ring 48 may be attached to the shaft portion 80 with the O ring 48 compressed outward in the radial direction of the shaft portion 80.

If there is a play between the O ring 48 and the shaft portion 80, the O ring 48 may not stay stable relative to the shaft portion 80. If the O ring 48 staggers relative to the shaft portion 80, the O ring 48 (or shaft portion 80) may be worn by the O ring 48 and the shaft portion 80 contacting each other. According to the above configuration, since there is no play between the O ring 48 and the shaft portion 80, the O ring 48 can be suppressed from staggering relative to the shaft portion 80. Due to this, the O ring 48 (or shaft portion 80) can be suppressed from being worn.

In one or more embodiments, the O ring 48 may be hidden by the locking plate 46 when viewed from the proximal side of the shaft portion 80.

If the O ring 48 is not hidden by the locking plate 46 when viewed from the proximal side of the shaft portion 80, design of appearance of the pruning scissors 2 may be impaired. According to the above configuration, design of the pruning scissors 2 can be improved because the O ring 48 is hidden by the locking plate 46 when viewed from the proximal side of the shaft portion 80.

What is claimed is:

1. A cutter machine, comprising:
a first blade;
a second blade configured to rotate relative to the first blade;
a base member supporting the first blade and the second blade;
a screw member including a head portion and a shaft portion extending from the head portion which is a proximal end of the shaft portion and threaded with an outer thread, wherein the screw member fastens the first blade and the base member to each other by having the outer thread screwed with an inner thread;
a looseness restraint member attached to the shaft portion and configured to be pressed by the head portion to restrain loosening of the screw member; and
a fall-off restraint member attached to the shaft portion on a distal side of the shaft portion relative to the looseness restraint member and configured to restrain the looseness restraint member from moving relative to the shaft portion in a direction from a proximal side to the distal side of the shaft portion.

2. The cutter machine according to claim 1, wherein
the looseness restraint member comprises:
a first surface facing to the proximal side of the shaft portion; and
a second surface facing to the distal side of the shaft portion, and
a shape of the first surface when viewed from the proximal side of the shaft portion and a shape of the second surface when viewed from the distal side of the shaft portion are different from each other.

3. The cutter machine according to claim 1, wherein
the looseness restraint member comprises:
a plate portion extending along a substantial truncated conical shape increasing in diameter in the direction from the proximal side to the distal side of the shaft portion; and
a plurality of teeth disposed on at least one of an inner circumference of the plate portion and an outer circumference of the plate portion, each of the plurality of teeth protruding in a direction along which the plate portion extends, and
the fall-off restraint member is an elastic member having a substantial ring shape.

4. The cutter machine according to claim 1, wherein
the first blade or the base member comprises:
a through-hole through which the shaft portion is configured to pass;
a contact surface configured to contact the looseness restraint member; and
a recess disposed along a periphery of the through-hole and configured to allow at least a part of the fall-off restraint member to retreat to an inner side relative to the contact surface.

5. The cutter machine according to claim 4, wherein
the recess is smoothly connected to the contact surface.

6. The cutter machine according to claim 1, further comprising:
a motor shaft connected to the second blade; and
an electric motor configured to rotate the motor shaft,
wherein
by the electric motor being driven, the first blade and the second blade are rotated relative to each other to perform a cutting operation.

7. The cutter machine according to claim 1, wherein
the fall-off restraint member is attached to the shaft portion with the fall-off restraint member compressed outward in a radial direction of the shaft portion.

8. The cutter machine according to claim 1, wherein
the fall-off restraint member is hidden by the looseness restraint member when viewed from the proximal side of the shaft portion.

9. The cutter machine according to claim 2, wherein
the looseness restraint member comprises:
a plate portion extending along a substantial truncated conical shape increasing in diameter in the direction from the proximal side to the distal side of the shaft portion; and
a plurality of teeth disposed on at least one of an inner circumference of the plate portion and an outer circumference of the plate portion, each of the plurality of teeth protruding in a direction along which the plate portion extends,
the fall-off restraint member is an elastic member having a substantial ring shape,
the first blade or the base member comprises:
a through-hole through which the shaft portion is configured to pass;
a contact surface configured to contact the looseness restraint member; and
a recess disposed along a periphery of the through-hole and configured to allow at least a part of the fall-off restraint member to retreat to an inner side relative to the contact surface,
the recess is smoothly connected to the contact surface,
the cutter machine further comprises:
a motor shaft connected to the second blade; and
an electric motor configured to rotate the motor shaft,
by the electric motor being driven, the first blade and the second blade are rotated relative to each other to perform a cutting operation,
the fall-off restraint member is attached to the shaft portion with the fall-off restraint member compressed outward in a radial direction of the shaft portion, and
the fall-off restraint member is hidden by the looseness restraint member when viewed from the proximal side of the shaft portion.
